(19) United States
(12) Patent Application Publication
(10) Pub. No.: US 2007/0071286 A1
(43) Pub. Date: Mar. 29, 2007

(54) Multiple biometric identification system and method

(76) Inventors: Yong Jin Lee, Ansan-city (KR); Do Sung Ahn, Seongnam-city (KR); Woo Yong Choi, Daejeon-city (KR); Ki Young Moon, Daejeon-city (KR); Kyo Il Chung, Daejeon-city (KR); Sung Won Sohn, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/521,862

(22) Filed: Sep. 15, 2006

(30) Foreign Application Priority Data
Sep. 16, 2005 (KR) 10-2005-0087027

(51) Int. Cl. G06K 9/00

(52) U.S. Cl. 382/115

(57) ABSTRACT

A multiple biometric identification system and method are provided. In the multiple biometric identification system and method, a plurality of unified comparison values are generated for respective corresponding candidates who may have different combinations of biometric identification information so that the comparison value vectors of the candidates can be effectively compared with one another. Therefore, it is possible to enable multiple biometric identification even when the type and quantity of biometric information differs from one candidate to.

### CROSS-REFERENCE TO RELATED PATENT APPLICATION

This application claims the benefit of Korean Patent Application No. 10-2005-0087027, filed on Sep. 16, 2005, in the Korean Intellectual Property Office, the disclosure of which is incorporated herein in its entirety by reference.

### BACKGROUND OF THE INVENTION

1. Field of the Invention

The present invention relates to a multiple biometric identification system using a plurality of comparison values respectively provided by a plurality of single biometric identification systems, and more particularly, to a multiple biometric identification system and method which can perform multiple biometric identification even when the quantity and type of biometric information differs from one candidate to another.

2. Description of the Related Art

For a better understanding of this disclosure, the terms ‘user’ and ‘candidate’ will now be defined. A user is a person who wants to be identified as one of a plurality of candidates whose biometric information is registered with a database. A candidate is a person whose biometric information is registered with a database and whose identity is well known. In other words, a candidate may be a potential user.

Biometric identification systems identify individuals based on biometric information of the individuals. Biometric identification systems use either a verification method or an identification method to identify individuals.

In the verification method, it is determined whether a user is the person who the user claims to be by using a one-to-one comparison method. On the other hand, in the identification method, a user is identified as being one of a plurality of candidates registered with a database by using a one-to-many comparison method. In other words, the verification method returns as a verification result a binary class value indicating whether a user is the person who the user claims to be, for example, the answer ‘yes’ or ‘no’. On the other hand, in the identification method, the probability of each of a plurality of candidates matching a user is calculated, and a candidate list in which the candidates are sequentially arranged according to their likelihood of matching the user is generated as an identification result.

In biometric identification, physical characteristics of individuals such as the face, fingerprints and the iris and behavioral characteristics of individuals such as signatures, walking style, and voice are used. Single biometric identification uses only one biometric characteristic of a user to identify the user. However, face recognition is sensitive to variations in illumination, and fingerprint recognition may often end up with false positives or false negatives when scanners are polluted with sweat or moist. Therefore, none of the pre-existing single biometric identification methods such as face recognition and fingerprint recognition are deemed perfect. In particular, in the case of single biometric identification methods, the degree of freedom in terms of representing biometric properties is very low. Thus, it is difficult to realize high-performance, high-reliability biometric identification systems using a single biometric identification method in which a considerable number of individuals are identified based on only one biometric property of the individuals. The performance and reliability of biometric identification systems can be improved by performing user identification based on more than one biometric property.

Conventional multiple biometric identification systems compare biometric information of a user with biometric information of candidates, generate biometric information comparison value vectors for the respective candidates, and generate a candidate list based on discriminant values obtained by a binary classifier using the biometric information comparison value vectors. However, in order to generate a candidate list based on discriminant values provided by a binary classifier, the type and quantity of biometric information of all of the candidates must be identical.

In such multiple biometric identification method, only a partial combination of biometric traits among multiple biometric traits which are considered in the system design is available.

For example, a multiple biometric identification system can identify individuals based on, for example, face, fingerprint, and vein pattern information. Some of a plurality of candidates may accidentally forget to input their fingerprint information to the multiple biometric identification system or may fail to input their fingerprint information to the multiple biometric identification system due to external factors. For example, it is possible that biometric information of three candidates registered with a database is as follows: face, fingerprint, and vein pattern information of the first candidate; face and fingerprint information of the second candidate; and vein pattern information of the third candidate. In this case, face, fingerprint, and vein pattern information of a user is compared with the face, fingerprint, and vein pattern information of the first candidate, thereby generating three biometric information comparison values. The face and fingerprint information of the user is compared with the face and fingerprint information of the second candidate, thereby generating two biometric information comparison values. The vein pattern information of the user is compared with the vein pattern information of the third candidate, thereby generating only one biometric information comparison value.

Since the types and quantity of biometric information comparison values may differ from one candidate to another, binary classifiers, e.g., a first binary classifier learned from a combination of face/fingerprint/vein pattern information comparison value vectors, a second binary classifier learned from a combination of face/fingerprint information comparison value vectors, and a third binary classifier learned from a vein pattern information comparison value vector, are needed to determine which of the first through third candidates is a match for the user based on combinations of biometric information values for the respective candidates. Therefore, a discriminant value provided by the first binary classifier is used to determine whether the first candidate is a match for the user, a discriminant value provided by the second binary classifier is used to determine whether the second candidate is a match for the user, and a discriminant value provided by the third binary classifier is used to determine whether the third candidate is a match for the user. A discriminant value provided by a binary classifier represents the distance between a biometric information comparison value vector and a predetermined decision boundary. Accordingly, it is meaningless to compare the discriminant values respectively provided by the first, second, and third binary classifiers because the discriminant values are obtained from different types of biometric information comparison value vectors. A comparison of discriminant values for respective corresponding candidates is only meaningful when the candidates have the same type and quantity of biometric information registered with a database.

Thus, when the quantity and type of biometric information registered with a database differs from one candidate to another, it is difficult to identify a user using a conventional multiple biometric identification method.

### SUMMARY OF THE INVENTION

The present invention provides a multiple biometric identification system and method which can perform multiple biometric identification even when the quantity and type of biometric information differs from one candidate to another.

The present invention also provides a computer-readable recording medium storing a computer program for executing the multiple biometric identification method.

According to an aspect of the present invention, -there is provided a multiple biometric identification system which identifies multiple biometric information of a user who requests to be identified, the multiple biometric identification system comprising: a biometric identification unit which compares multiple biometric information of the user with multiple biometric information of each of a plurality of candidates registered in advance, thereby generating a plurality of single biometric information comparison values for respective corresponding pieces of single biometric information constituting the multiple biometric information of each of the candidates; a comparison value processing unit which generates a plurality of comparison value vectors for the respective candidates based on the single biometric information comparison values and classifies the comparison value vectors according to the combination of single biometric information of each of the comparison value vectors; a comparison value generation unit which converts the comparison value vectors generated by the comparison value processing unit into a plurality of unified comparison values for the respective candidates so that the candidates which have different combinations of single biometric information can be effectively sorted according to their possibilities of being the users; and an identification list generation unit which generates a candidate list in which the candidates who are likely to be determined to be a match for the user through multiple biometric identification based on the single comparison values are listed in a predetermined manner.

According to another aspect of the present invention, there is provided a multiple biometric identification system method of identifying multiple biometric information of a user who requests to be identified using a plurality of single biometric identification systems, the multiple biometric identification method comprising: (a) comparing multiple biometric information of the user with multiple biometric information of each of a plurality of candidates registered in advance using each of the single biometric identification systems, thereby generating a plurality of single biometric information comparison values for respective corresponding pieces of the multiple biometric information of each of the candidates; (b) generating a plurality of comparison value vectors for the respective candidates based on the single biometric information comparison values; (c) classifying the comparison value vectors according to the combination of single biometric information of each of the comparison value vectors; (d) converting the classified comparison value vectors into a plurality of unified comparison values for the respective candidates so that the candidates which have different combinations of single biometric information can be effectively sorted according to their possibilities of being the user; and (e) generating a candidate list in which the candidates who are likely to be determined to be a match for the user through multiple biometric identification based on the single comparison values are listed in a predetermined manner.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a multiple biometric identification system according to an exemplary embodiment of the present invention;

FIG. 2 is a flowchart illustrating a multiple biometric identification method according to an exemplary embodiment of the present invention;

FIG. 3 is a block diagram of a first unified comparison value generator illustrated in FIG. 1, according to an exemplary embodiment of the present invention;

FIG. 4 is a block diagram of a second unified comparison value generator illustrated in FIG. 1, according to an exemplary embodiment of the present invention;

FIG. 5 is a block diagram of a fifth unified comparison value generator illustrated in FIG. 1, according to an exemplary embodiment of the present invention;

FIG. 6 is a block diagram of a first unified comparison value generator illustrated in FIG. 1, according to another exemplary embodiment of the present invention;

FIG. 7 is a block diagram of a second unified comparison value generator illustrated in FIG. 1, according to another exemplary embodiment of the present invention;

FIG. 8 is a block diagram of a fifth unified comparison value generator illustrated in FIG. 1, according to another exemplary embodiment of the present invention;

FIG. 9 is a block diagram of a first unified comparison value generator illustrated in FIG. 1, according to another exemplary embodiment of the present invention;

FIG. 10 is a block diagram of a second unified comparison value generator illustrated in FIG. 1, according to another exemplary embodiment of the present invention;

FIG. 11 is a block diagram of a fifth unified comparison value generator illustrated in FIG. 1, according to another exemplary embodiment of the present invention;

FIG. 12 is a block diagram of a first unified comparison value generator illustrated in FIG. 1, according to another exemplary embodiment of the present invention;

FIG. 13 is a block diagram of a second unified comparison value generator illustrated in FIG. 1, according to another exemplary embodiment of the present invention; and

FIG. 14 is a block diagram of a fifth unified comparison value generator illustrated in FIG. 1, according to another exemplary embodiment of the present invention.

### DETAILED DESCRIPTION OF THE INVENTION

The present invention will now be described more fully with reference to the accompanying drawings in which exemplary embodiments of the invention are shown.

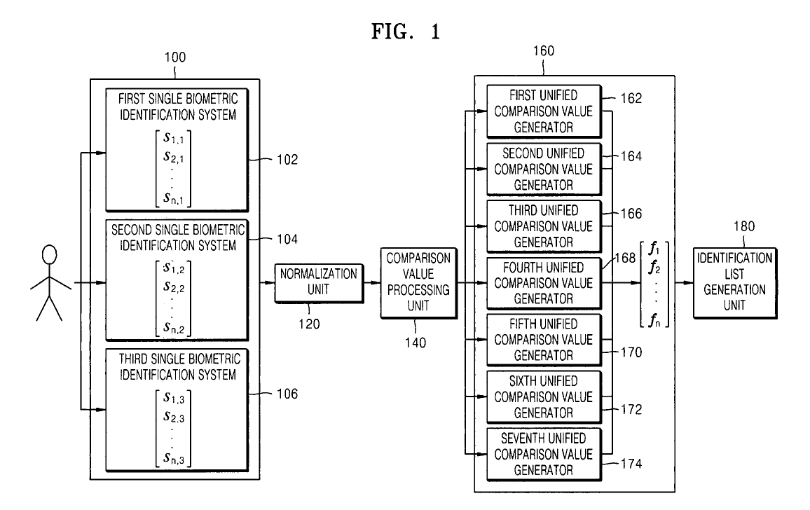

FIG. 1 is a block diagram of a multiple biometric identification system according to an exemplary embodiment of the present invention. Referring to FIG. 1, the multiple biometric identification system performs biometric identification using 3 pieces of single biometric information, and includes a biometric identification system 100, a normalization unit 120, a comparison value processing unit 140, a comparison value generation unit 160 and an identification list generation unit 180.

The biometric identification system 100 compares multiple biometric information of a user who requests to be identified with multiple biometric information of a plurality of candidates registered in advance, thereby generating a plurality of biometric information comparison values. In detail, the biometric identification system 100 includes a first single biometric identification system 102, a second single biometric identification system 104, and a third single biometric identification system 106. A plurality of pieces of biometric information of the user are respectively input to the first single biometric identification system 102, the second single biometric identification system 104, and the third single biometric identification system 106. For example, if the multiple biometric identification system illustrated in FIG. 1 performs biometric identification using face information, fingerprint information, and vein information of the user, the first, second, and third single biometric identification systems 102, 104, and 106 respectively recognize the face information, the fingerprint information, and the vein information of the user. Thus, the face information, the fingerprint information, and the vein information of the user are input to the first, second, and third single biometric identification systems 102, 104, and 106, respectively.

The first single biometric identification system 102 generates a plurality of first biometric information comparison values [S_{1,1}, S_{2,1}, . . . , S_{n,1}] by comparing first biometric information of the user with a plurality of pieces of first biometric information of a plurality of candidates (e.g., first through n-th candidates), which are registered in advance with the first single biometric identification system 102. The first biometric information comparison value s_{i,1} (where 1≦i≦n) is generated by comparing the first biometric information of the user with the first biometric information of an i-th candidate.

Likewise, the second single biometric identification system 104 generates a plurality of second biometric information comparison values [S_{1,2}, S_{2,2}, . . . , S_{n,2}] by comparing second biometric information of the user with a plurality of pieces of second biometric information of the n candidates, which are registered in advance with the second single biometric identification system 104. The second biometric information comparison value S_{i,2} is generated by comparing the second biometric information of the user with the second biometric information of the i-th candidate.

Likewise, the third single biometric identification system 106 generates a plurality of third biometric information comparison values [S_{1,3}, S_{2,3}, . . . , S_{n,3}] by comparing third biometric information of the user with a plurality of pieces of third biometric information of the n candidates, which are registered in advance with the third single biometric identification system 106. The third biometric information comparison value S_{i,3} is generated by comparing the third biometric information of the user with the third biometric information of the i-th candidate.

The normalization unit 120 normalizes the first biometric information comparison values [S_{1,1}, S_{2,1}, . . . , S_{n,1}], the second biometric information comparison values [S_{1,2}, S_{2,2}, . . . , S_{n,2}], and the third biometric information comparison values [S_{1,3}, S_{2,3}, . . . , S_{n,3}] to a common range such that they have common units. The first, second, and third single biometric identification systems 102, 104, and 106 may generate biometric information comparison values using different methods. In other words, some of the first, second, and third single biometric identification systems 102, 104, and 106 may generate a value indicating how much biometric information of a candidate is similar to biometric information of the user as a biometric information comparison value for the candidate, while the other single biometric identification system(s) may generate a value indicating how much the biometric information of the candidate is dissimilar to the biometric information of the user as the biometric information comparison value for the candidate. Thus, the normalization of the first biometric information comparison values [S_{1,1}, S_{2,1}, . . . , S_{n,1}], the second biometric information comparison values [S_{1,2}, S_{2,2}, . . . , S_{n,2}], and the third biometric information comparison values [S_{1,3}, S_{2,3}, . . . , S_{n,3}] is conducted to normalize the corresponding biometric information comparison values to be either similarity-based biometric information comparison values or dissimilarity-based biometric information comparison values. In addition, the first, second, and third single biometric identification systems 102, 104, and 106 may generate different ranges of biometric information comparison values. Thus, the normalization of the first biometric information comparison values [S_{1,1}, S_{2,1}, . . . , S_{n,1}], the second biometric information comparison values [S_{1,2}, S_{2,2}, . . . , S_{n,2}], and the third biometric information comparison values [S_{1,3}, S_{2,3}, . . . , S_{n,3}] is conducted to normalize the corresponding biometric information comparison values to a common range, e.g., a range between 0 and 1 or a range between 0 and 100, thereby facilitating the user's recognition of the corresponding biometric information comparison values. In order to facilitate the estimation of probability distributions by the comparison value generation unit 160, facilitate the learning of a binary classifier, and enhance the performance of biometric identification, various common ranges may be used.

The comparison value processing unit 140 generates n comparison value vectors for the respective candidates based on the first biometric information comparison values [S_{1,1}, S_{2,1}, . . . , S_{n,1}], the second biometric information comparison values [S_{1,2}, S_{2,2}, . . . , S_{n,2}], and the third biometric information comparison values [S_{1,3}, S_{2,3}, . . . , S_{n,3}]. If one of the first through third biometric information of a predetermined candidate is unregistered, and thus a biometric information comparison value for the predetermined candidate is null, a comparison value vector for the predetermined candidate may be generated based on only the registered biometric information. For example, if the first through third biometric information of the first candidate is all registered, a comparison value vector for the first candidate may be generated as [S_{1,1}, S_{1,2}, S_{1,3}]. If only the first and third biometric information of the second candidate is registered, a comparison value vector for the second candidate may be generated as [S_{2,1}, S_{2,3}]. If only the third biometric information of the third candidate is registered, a comparison value vector for the third candidate may be generated as [S_{3,3}]. The comparison value processing unit 140 classifies the n comparison value vectors generated in the aforementioned manner according to the biometric information combinations respectively used to generate the n comparison value vectors, i.e., according to the types and quantity of biometric information included in each of the n comparison value vectors, and provides the classified results to the comparison value generation unit 160.

The comparison value generation unit 160 generates n unified comparison values [f₁, f₂, . . . , fₙ] for the respective candidates so that the user can be identified as one of the candidates by comparing the user to the candidates, which may have different combinations of biometric information. The first unified comparison value f₁ is for the first candidate, the second unified comparison value f₂ is for the second candidate, and the n-th unified comparison value fₙ is for the n-th candidate. In detail, the comparison value generation unit 160 comprises a plurality of first through seventh unified comparison value generators 162 through 174 corresponding to the number of possible combinations of biometric information to be recognized. The first through seventh unified comparison value generators 162 through 174 generate the first through n-th unified comparison values using the comparison value vectors classified and provided by the comparison value processing unit 140.

In detail, the first unified comparison value generator 162 is provided with a predetermined comparison value vector comprising the first, second, and third biometric information of a candidate by the comparison value processing unit 140 and generates a unified comparison value so that the comparison value vector can be compared with a comparison value vector comprised of a different biometric information combination than the predetermined comparison value vector.

The second unified comparison value generator 164 is provided with a predetermined comparison value vector comprising the first and second biometric information of a candidate by the comparison value processing unit 140 and generates a unified comparison value so that the predetermined comparison value vector can be compared with a comparison value vector comprised of a different biometric information combination than the predetermined comparison value vector.

The third unified comparison value generator 166 is provided with a predetermined comparison value vector comprising the first and third biometric information of a candidate by the comparison value processing unit 140 and generates a unified comparison value so that the predetermined comparison value vector can be compared with a comparison value vector comprised of a different biometric information combination than the predetermined comparison value vector.

The third unified comparison value generator 168 is provided with a predetermined comparison value vector comprising the first biometric information of a candidate by the comparison value processing unit 140 and generates a unified comparison value so that the predetermined comparison value vector can be compared with a comparison value vector comprised of a different biometric information combination than the predetermined comparison value vector.

The fifth unified comparison value generator 170 is provided with a predetermined comparison value vector comprising the first biometric information of a candidate by the comparison value processing unit 140 and generates a unified comparison value so that the predetermined comparison value vector can be compared with a comparison value vector comprised of a different biometric information combination than the predetermined comparison value vector.

The sixth unified comparison value generator 172 is provided with a predetermined comparison value vector comprising the second biometric information of a candidate by the comparison value processing unit 140 and generates a unified comparison value so that the predetermined comparison value vector can be compared with a comparison value vector comprised of a different biometric information combination than the predetermined comparison value vector.

The seventh unified comparison value generator 174 is provided with a predetermined comparison value vector comprising the third biometric information of a candidate by the comparison value processing unit 140 and generates a unified comparison value so that the predetermined comparison value vector can be compared with a comparison value vector comprised of a different biometric information combination than the predetermined comparison value vector.

The first through seventh unified comparison value generators 162 through 174 may generate a unified comparison value using one of the following 4 methods:
(1) A method using a posterior probability of a comparison value vector;
(2) A method using the log of an odds ratio between posterior probabilities calculated based on class-conditional probabilities of a comparison value vector;
(3) A method using a discriminant value of a binary classifier for a comparison value vector and a posterior probability of the discriminant value; and
(4) A method using a discriminant value of a binary classifier for a comparison value vector and the log of an odds ratio between posterior probabilities calculated based on class-conditional probabilities of a comparison value vector

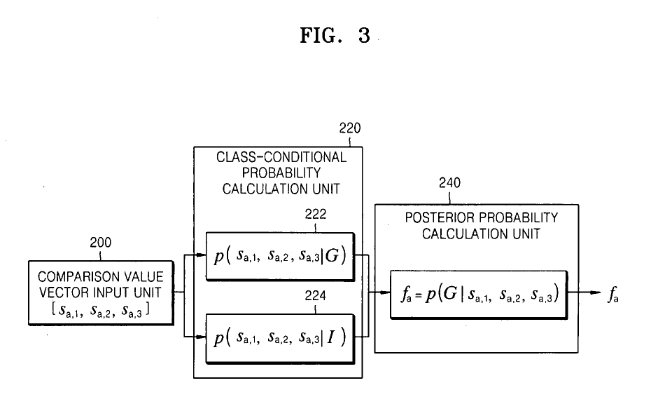

The generation of unified comparison values using the above 4 methods will be described in detail later with reference to FIGS. 3 through 14.

The identification list generation unit 180 generates a candidate list in which the candidates who are likely to be determined to be a match for the user through multiple biometric identification are listed in order from the candidate with the highest probability of being the match for the user to the candidate with the lowest probability of being the match for the user or vice versa by performing multiple biometric identification using the first through n-th unified comparison values [f₁, f₂, . . . , fₙ].

For simplicity, the biometric identification system 100 is illustrated in FIG. 1 as comprising only 3 single biometric identification units (102 through 106). However, the present invention is not limited thereto. Also, the biometric identification system 100 may be comprised of a plurality of single biometric identification units which use different biometric identification methods to identify the same living body.

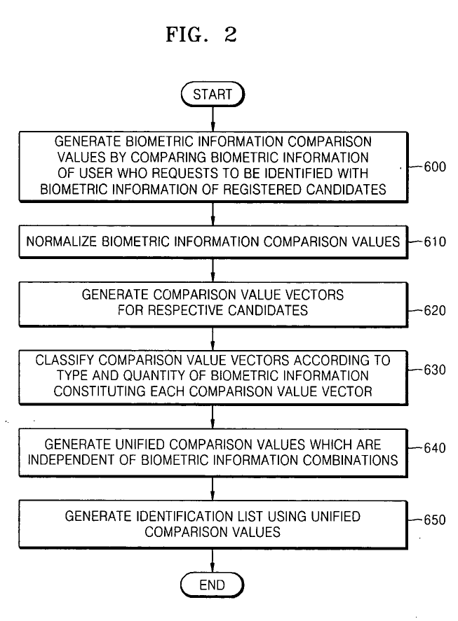

FIG. 2 is a flowchart illustrating a multiple biometric identification method according to an exemplary embodiment of the present invention. Referring to FIGS. 1 and 2, in operation 600, the biometric identification system 100 compares multiple biometric information of a user who requests to be identified with biometric information of a plurality of candidates registered in advance, thereby generating a plurality of single biometric information comparison values for the respective candidates.

In operation 610, the normalization unit 120 normalizes the single biometric information comparison values so that the single biometric information comparison values are in the same range and have the same units.

In operation 620, the comparison value processing unit 140 generates a plurality of comparison value vectors for the respective candidates based on the single biometric information comparison values. In operation 630, the comparison value processing unit 140 classifies the comparison value vectors according to the type and quantity of biometric information constituting the comparison value vectors.

In operation 640, the comparison value generation unit 160 converts the comparison value vectors classified by the comparison value processing unit 140 into a plurality of unified comparison values [f₁, f₂, . . . , fₙ] for the respective candidates, thereby facilitating the comparison of the user with the candidates, who may have different combinations of biometric information.

In operation 650, the identification list generation unit 180 generates a candidate list in which the candidates who are likely to be determined to be a match for the user through multiple biometric identification are listed in order from the candidate with the highest probability of being a match for the user to the candidate with the lowest probability of being a match for the user or vice versa based on the unified comparison values [f₁, f₂, . . . , fₙ] generated by the comparison value generation unit 160.

As described above, the comparison value generation unit 160 generates the unified comparison values [f₁, f₂, . . . , fₙ] for the respective candidates so that the user can be effectively compared with the candidates, who may have different combinations of biometric information. Therefore, it is possible to enable multiple biometric identification even when the quantity and type of biometric information of the candidates registered with a database vary.

FIGS. 3 through 5 are respective block diagrams of examples of the first, second, and fifth unified comparison value generators 162, 164, and 170 illustrated in FIG. 1. Referring to FIGS. 3 through 5, the first, second, and fifth unified comparison value generators 162, 164, and 170 respectively include comparison value vector input units 200, 200′, and 200″, class-conditional probability calculation units 220, 220′, and 220″, and posterior probability calculation units 240, 240′, and 240″. A method of generating a unified comparison value using the posterior probability of a comparison value vector will now be described in detail with reference to FIGS. 3 through 5.

Referring to FIG. 3, the comparison value vector input unit 200 receives from the comparison value processing unit 140 a comparison value vector [S_{a,1}, S_{a,2}, S_{a,3}] of an a-th candidate having first through third biometric information registered.

The class-conditional probability calculation unit 220 calculates a class-conditional probability P(S_{a,1}, S_{a,2}, S_{a,3}|G) (222) and a class-conditional probability P(S_{a,1}, S_{a,2}, S_{a,3}|I) (224). The class-conditional probability P(S_{a,1}, S_{a,2}, S_{a,3}|G) (222) is the likelihood that a comparison value vector generated by comparing first, second, and third biometric information is observed from a class G, and the class-conditional probability P(S_{a,1}, S_{a,2}, S_{a,3}|I) (224) is the likelihood that a comparison value vector generated by comparing first, second, and third biometric information is observed from a class I.

Here, G indicates a class of comparison value vectors generated by comparing a plurality of pieces of biometric information of the same person, and I indicates a class of comparison value vectors generated by comparing a plurality of pieces of biometric information of different persons.

In order to calculate the class-conditional probability P(S_{a,1}, S_{a,2}, S_{a,3}|G) (222) and the class-conditional probability P(S_{a,1}, S_{a,2}, S_{a,3}|I) (224), a comparison value vector probability distribution P(S₁, S₂, S₃|G) and a comparison value vector probability distribution P(S₁, S₂, S₃|I) must be estimated. The comparison value vector probability distributions P(S₁, S₂, S₃|G) and P(S₁, S₂, S₃|I) can be obtained through estimation by using comparison value vectors generated by comparing first through third biometric information of the same person and comparison value vectors generated by comparing first through third biometric information of different persons respectively. The estimation of the comparison value vector probability distributions P(S₁, S₂, S₃|G) and P(S₁, S₂, S₃|I) may be conducted using a parametric method, a semi-parametric method, or a non-parametric method, which will be more apparent with reference to Neural Networks for Pattern Recognition, Christopher M. Bishop, Oxford.

The posterior probability calculation unit 240 calculates a posterior probability P(G|S_{a,1}, S_{a,2}, S_{a,3}), which is the probability that the input comparison value vector [S_{a,1}, S_{a,2}, S_{a,3}] has been generated by comparing a plurality of pieces of biometric information of the same person, using the class-conditional probabilities P(S_{a,1}, S_{a,2}, S_{a,3}|G) (222) and P(S_{a,1}, S_{a,2}, S_{a,3}|I) (224) and prior probabilities P(G) and P(I), and provides the calculation result as a unified comparison value fₐ for the input comparison value vector [S_{a,1}, S_{a,2}, S_{a,3}], and more particularly, for the a-th candidate. The prior probabilities P(G) and P(I) are not values estimated from comparison value vectors but values predefined based on a system designer's experience and prior knowledge.

The posterior probability P(G|S_{a,1}, S_{a,2}, S_{a,3}) is calculated as indicated in Equation (1):

$${f}_{a} = P ( G \vert {s}_{a , 1} , {s}_{a , 2} , {s}_{a , 3} ) = \frac{P ( {s}_{a , 1} , {s}_{a , 2} , {s}_{a , 3} \vert G ) P ( G )}{P ( {s}_{a , 1} , {s}_{a , 2} , {s}_{a , 3} \vert G ) P ( G ) + P ( {s}_{a , 1} , {s}_{a , 2} , {s}_{a , 3} \vert I ) P ( I )} \qquad Λ ( 1 ) .$$

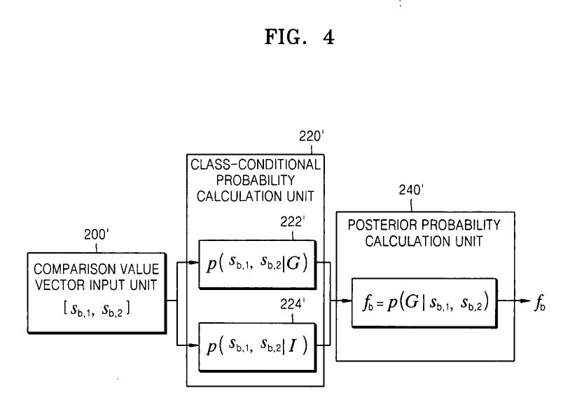

Referring to FIG. 4, the comparison value vector input unit 200′ receives from the comparison value processing unit 140 a comparison value vector [S_{b,1}, S_{b,2}] of a b-th candidate for which first and second biometric information is registered.

The class-conditional probability calculation unit 220′ calculates a class-conditional probability P(S_{b,1}, S_{b,2}|G) (222′) and a class-conditional probability P(S_{b,1}, S_{b,2}|I) (224′). The class-conditional probability P(S_{b,1}, S_{b,2}|G) (222′) is the likelihood that a comparison value vector generated by comparing first and second biometric information is observed from the class G, and the class-conditional probability P(S_{b,1}, S_{b,2}|I) (224′) is the likelihood that a comparison value vector generated by comparing first and second biometric information is observed from the class I.

In order to calculate the class-conditional probability P(S_{b,1}, S_{b,2}|G) (222′) and the class-conditional probability P(S_{b,1}, S_{b,2}|I) (224′), a comparison value vector probability distribution P(S₁, S₂|G) and a comparison value vector probability distribution P(S₁, S₂|I) must be estimated. The estimation of the comparison value vector probability distributions P(S₁, S₂|G) and P(S₁, S₂|I) may be conducted in the same manner as described above with reference to FIG. 3.

The posterior probability calculation unit 240′ calculates a posterior probability P(G|S_{b,1}, S_{b,2}), which is the probability that the input comparison value vector [S_{b,1}, S_{b,2}] has been generated by comparing a plurality of pieces of biometric information of the same person, using the class-conditional probabilities P(S_{b,1}, S_{b,2}|G) (222′) and P(S_{b,1}, S_{b,2}|I) (224′) and the prior probabilities P(G) and P(I), and provides the calculation result as a unified comparison value f_{b} for the input comparison value vector [S_{b,1}, S_{b,2}], and more particularly, for the b-th candidate.

The posterior probability P(G|S_{b,1}, S_{b,2}) is calculated as indicated in Equation (2):

$${f}_{b} = P ( G \vert {s}_{b , 1} , {s}_{b , 2} ) = \frac{P ( {s}_{b , 1} , {s}_{b , 2} \vert G ) P ( G )}{P ( {s}_{b , 1} , {s}_{b , 2} \vert G ) P ( G ) + P ( {s}_{b , 1} , {s}_{b , 2} \vert I ) P ( I )} \qquad Λ ( 2 ) .$$

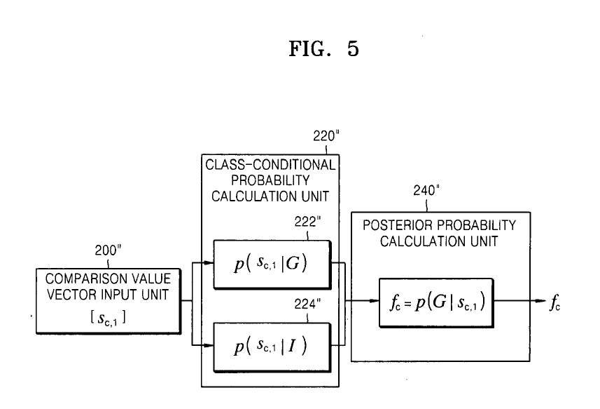

Referring to FIG. 5, the comparison value vector input unit 200″ receives from the comparison value processing unit 140 a comparison value vector [S_{c,1}] of a c-th candidate for which first biometric information is registered.

The class-conditional probability calculation unit 220′ calculates a class-conditional probability P(S_{c,1}|G) (222″) and a class-conditional probability P(S_{c,1}|I) (224″). The class-conditional probability P(S_{c,1}|G) (222″) is the likelihood that a comparison value vector generated by comparing first biometric information is observed from the class G, and the class-conditional probability P(S_{c,1}|I) (224″) is the likelihood that a comparison value vector generated by comparing first biometric information is observed from the class I.

In order to calculate the class-conditional probability P(S_{c,1}|G) (222″) and the class-conditional probability P(S_{c,1}|I) (224″), a comparison value vector probability distribution P(S_{c,1}|G) and a comparison value vector probability distribution P(S_{c,1}|I) must be estimated. The estimation of the comparison value vector probability distributions P(S₁|G) and P(S₁|I) may be conducted in the same manner as described above with reference to FIG. 3.

The posterior probability calculation unit 240″ calculates a posterior probability P(G|S_{c,1}), which is the probability that the input comparison value vector [S_{c,1}] has been generated by comparing a plurality of pieces of biometric information of the same person, using the class-conditional probabilities P(S_{c,1}|G) (222″) and P(S_{c,1}|I) (224″) and the prior probabilities P(G) and P(I), and provides the calculation result as a unified comparison valued, for the input comparison value vector[S_{c,1}], and more particularly, for the c-th candidate.

The posterior probability P(G|S_{c,1}) is calculated as indicated in Equation (3):

$${f}_{b} = P ( G \vert {s}_{c , 1} ) = \frac{P ( {s}_{c , 1} \vert G ) P ( G )}{P ( {s}_{c , 1} \vert G ) P ( G ) + P ( {s}_{c , 1} \vert I ) P ( I )} \qquad Λ ( 3 ) .$$

The unified comparison value generators other than those described above with reference to FIGS. 3 through 5 perform similar operations to those described above with reference to FIGS. 3 through 5, and thus, their detailed descriptions will be omitted.

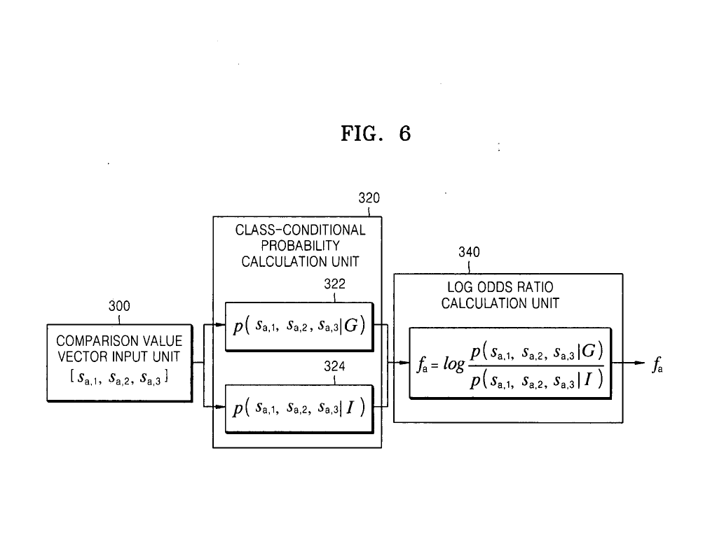

FIGS. 6 through 8 are block diagrams of the first, second, and fifth unified comparison value generators 162, 164, and 170, respectively, according to another embodiment of the present invention. Referring to FIGS. 3 through 5, the first, second, and fifth unified comparison value generators 162, 164, and 170 respectively include comparison value vector input units 300, 300′, and 300″, class-conditional probability calculation units 320, 320′, and 320″, and log of odds ratio calculation units 340, 340′, and 340″. A method of generating a unified comparison value using the log of the odds ratio between class-conditional probabilities will now be described in detail with reference to FIGS. 6 through 8. The comparison value vector input units 300, 300′, and 300″ perform the same operations as the comparison value vector input units 200, 200′, and 200″, respectively, described above with reference to FIGS. 3 through 5, and thus, their detailed descriptions will be omitted. The operation of the log of odds ratio calculation units 340, 340′, and 340″ will now be described in detail.

FIG. 6 is a schematic block diagram of the first unified comparison value generator 162 illustrated in FIG. 1. Referring to FIG. 6, the log of odds ratio calculation unit 340 calculates the log of the odds ratio of the posterior probability P(G|S_{a,1}, S_{a,2}, S_{a,3}) to the posterior probability P(I|S_{a,1}, S_{a,2}, S_{a,3}) using the class-conditional probabilities P(S_{a,1}, S_{a,2}, S_{a,3}|G) and P(S_{a,1}, S_{a,2}, S_{a,3}|I) calculated by the class-conditional probability calculation unit 320, and provides the log of the odds ratio of the posterior probability P(G|S_{a,1}, S_{a,2}, S_{a,3}) as the unified comparison value fₐ for the a-th candidate. The calculation of the unified comparison value fₐ for the a-th candidate will now be described in detail with reference to Equations (4) through (7). The log of the odds ratio of the posterior probability P(G|S_{a,1}, S_{a,2}, S_{a,3}) may be calculated as indicated in Equation (4):

$$log \frac{P ( G \vert {s}_{a , 1} , {s}_{a , 2} , {s}_{a , 3} )}{P ( I \vert {s}_{a , 1} , {s}_{a , 2} , {s}_{a , 3} )} \qquad Λ ( 4 ) .$$

The log of the odds ratio of the posterior probability P(G|S_{a,1}, S_{a,2}, S_{a,3}) is a monotonically increasing function with respect to the posterior probability P(G|S_{a,1}, S_{a,2}, S_{a,3}). Thus, the placement of the a-th candidate among a plurality of candidates included in a candidate list would be identical if the log of odds ratio of the posterior probability P(G|S_{a,1}, S_{a,2}, S_{a,3}) were used or if the posterior probability P(G|S_{a,1}, S_{a,2}, S_{a,3}) were used. The log of the odds ratio of the posterior probability P(G|S_{a,1}, S_{a,2}, S_{a,3}) is equal to the sum of the log of the odds ratio between the class-conditional probabilities P(5_{a,1}, S_{a,2}, S_{a,3}|G) and P(S_{a,1}, S_{a,2}, S_{a,3}|I) and the log of the odds ratio between the prior probabilities P(G) and P(I) as indicated in Equation (5):

$$\begin{matrix}log \frac{P ( G \vert {s}_{a , 1} , {s}_{a , 2} , {s}_{a , 3} )}{P ( I \vert {s}_{a , 1} , {s}_{a , 2} , {s}_{a , 3} )} = log \frac{\frac{P ( {s}_{a , 1} , {s}_{a , 2} , {s}_{a , 3} \vert G ) P ( G )}{P ( {s}_{a , 1} , {s}_{a , 2} , {s}_{a , 3} \vert G ) P ( G ) + \\ P ( {s}_{a , 1} , {s}_{a , 2} , {s}_{a , 3} \vert I ) P ( I )}}{\frac{P ( {s}_{a , 1} , {s}_{a , 2} , {s}_{a , 3} \vert I ) P ( I )}{P ( {s}_{a , 1} , {s}_{a , 2} , {s}_{a , 3} \vert G ) P ( G ) + \\ P ( {s}_{a , 1} , {s}_{a , 2} , {s}_{a , 3} \vert I ) P ( I )}} \\ = log \frac{P ( {s}_{a , 1} , {s}_{a , 2} , {s}_{a , 3} \vert G ) P ( G )}{P ( {s}_{a , 1} , {s}_{a , 2} , {s}_{a , 3} \vert I ) P ( I )} \\ = log \frac{P ( {s}_{a , 1} , {s}_{a , 2} , {s}_{a , 3} \vert G )}{P ( {s}_{a , 1} , {s}_{a , 2} , {s}_{a , 3} \vert I )} + log \frac{P ( G )}{P ( I )}\end{matrix} \qquad Λ ( 5 )$$

where

$$log \frac{P ( G )}{P ( I )}$$

$$log \frac{P ( {s}_{a , 1} , {s}_{a , 2} , {s}_{a , 3} \vert G ) P ( G )}{\frac{\frac{P ( {s}_{a , 1} , {s}_{a , 2} , {s}_{a , 3} \vert G ) P ( G ) + \\ P ( {s}_{a , 1} , {s}_{a , 2} , {s}_{a , 3} \vert I ) P ( I )}{P ( {s}_{a , 1} , {s}_{a , 2} , {s}_{a , 3} \vert I ) P ( I )}}{P ( {s}_{a , 1} , {s}_{a , 2} , {s}_{a , 3} \vert G ) P ( G ) + \\ P ( {s}_{a , 1} , {s}_{a , 2} , {s}_{a , 3} \vert I ) P ( I )}}$$

is a constant for all comparison value vectors, and thus does not affect the creation of a candidate list. In other words, the posterior probability P(G|S_{a,1}, S_{a,2}, S_{a,3}) and the log of the odds ratio of the posterior probability P(G|S_{a,1}, S_{a,2}, S_{a,3}) are relative as indicated in Equation (6):

$$P ( G \vert {s}_{a , 1} , {s}_{a , 2} , {s}_{a , 3} ) ∝ log \frac{P ( G \vert {s}_{a , 1} , {s}_{a , 2} , {s}_{a , 3 } )}{P ( I \vert {s}_{a , 1} , {s}_{a , 2} , {s}_{a , 3} )} ∝ log \frac{P ( {s}_{a , 1} , {s}_{a , 2} , {s}_{a , 3} \vert G )}{P ( {s}_{a , 1} , {s}_{a , 2} , {s}_{a , 3} \vert I )} \qquad Λ ( 6 ) .$$

Therefore, the unified comparison value fₐ for the a-th candidate is calculated as indicated in Equation (7):

$${f}_{a} = log \frac{P ( {s}_{a , 1} , {s}_{a , 2} , {s}_{a , 3} \vert G )}{P ( {s}_{a , 1} , {s}_{a , 2} , {s}_{a , 3} \vert I )} \qquad Λ ( 7 ) .$$

In the previous embodiment described above with reference to FIGS. 3 through 5, the posterior probability P(G|S_{a,1}, S_{a,2}, S_{a,3}) is provided as the unified comparison value fₐ for the a-th candidate. In this case, in order to calculate the posterior probability P(G|S_{a,1}, S_{a,2}, S_{a,3}), the prior probabilities P(G) and P(I), which are not values estimated from comparison value vectors but values predefined based on a system designer's experience and prior knowledge, must be estimated. However, in the current embodiment, the log of the odds ratio between the class-conditional probabilities P(S_{a,1}, S_{a,2}, S_{a,3}|G) and P(S_{a,1}, S_{a,2}, S_{a,3}|I) is provided as the unified comparison value fₐ for the a-th candidate. Therefore, it is possible to offer the same advantages as in the previous embodiment involving the use of the posterior probability P(G|S_{a,1}, S_{a,2}, S_{a,3}) without the need for a system designer to estimate the prior probabilities P(G) and P(I).

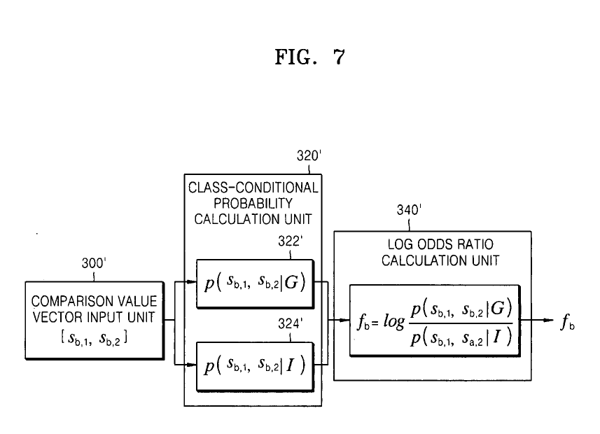

FIG. 7 is a schematic block diagram of the second unified comparison value generator 164 illustrated in FIG. 1. Referring to FIG. 7, the log of odds ratio calculation unit 340′ calculates the log of the odds ratio of the posterior probability P(G|S_{b,1}, S_{b,2}) using the class-conditional probabilities P(S_{b,1}, S_{b,2}|G) and P(S_{b,1}, S_{b,2}|I) calculated by the class-conditional probability calculation unit 320′ and provides the log of the odds ratio of the posterior probability P(G|S_{b,1}, S_{b,2}) as the unified comparison value f_{b} for the comparison value vector [S_{b,1}], S_{b,2}], and more particularly, for the b-th candidate. The calculation of the unified comparison value f_{b} for the b-th candidate is almost the same as the calculation of the unified comparison value fₐ for the a-th candidate described above with reference to FIG. 6, and the result is as indicated in Equation (8):

$${f}_{b} = log \frac{P ( {s}_{b , 1} , {s}_{b , 2} \vert G )}{P ( {s}_{b , 1} , {s}_{b , 2} \vert I )} \qquad Λ ( 7 ) .$$

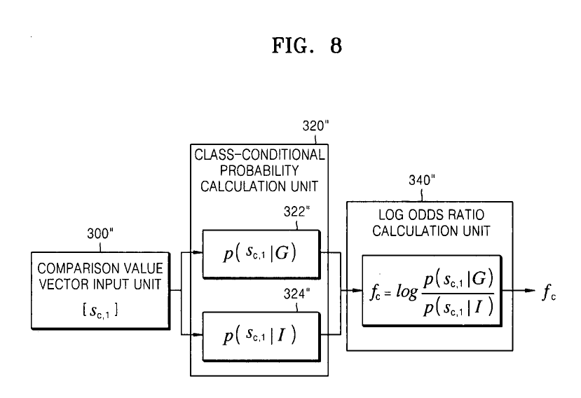

FIG. 8 is a schematic block diagram of the fifth unified comparison value generator 170 illustrated in FIG. 1. Referring to FIG. 8, the log of odds ratio calculation unit 340″ calculates the log of the odds ratio of the posterior probability P(G|S_{c,1}) using the class-conditional probabilities P(S_{c,1}|G) and P(S_{c,1}|I) calculated by the class-conditional probability calculation unit 320″ and provides the log of the odds ratio of the posterior probability P(G|S_{c,1}) as the unified comparison valued f_{c} for the comparison value vector [S_{c,1}], and more particularly, for the c-th candidate. The calculation of the unified comparison value f_{c} for the c-th candidate is almost the same as the calculation of the unified comparison value fₐ for the a-th candidate described above with reference to FIG. 6, and the result is as indicated in Equation (9):

$${f}_{c} = log \frac{P ( {s}_{c , 1} \vert G )}{P ( {s}_{c , 1} \vert I )} \qquad Λ ( 8 ) .$$

The unified comparison value generators other than those described above with reference to FIGS. 6 through 8 perform similar operations to those described above with reference to FIGS. 6 through 8, and thus, their detailed descriptions will be omitted.

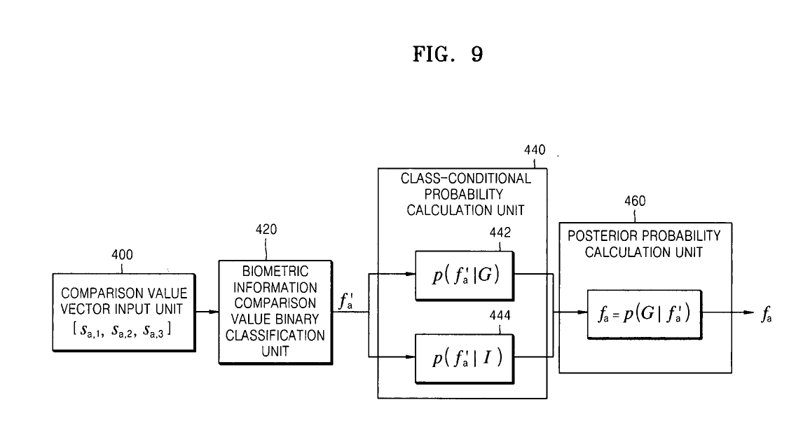

FIGS. 9 through 11 are block diagrams of the first, second, and fifth unified comparison value generators 162, 164, and 170, respectively, according to another embodiment of the present invention. Referring to FIGS. 9 through 11, the first, second and fifth unified comparison value generators 162, 164, and 170 respectively include comparison value vector input units 400, 400′, and 400″, biometric information comparison value binary classification units 420, 420′, and 420″, class-conditional probability calculation units 440, 440′, and 440″, and posterior probability calculation units 460, 460′, and 460″. A method of generating a unified comparison value using a discriminant value of a binary classifier for a comparison value vector and a posterior probability of the discriminant value will now be described in detail with reference to FIGS. 9 through 11.

FIG. 9 is a schematic block diagram of the first unified comparison value generator 162 illustrated in FIG. 1. Referring to FIG. 9, the comparison value vector input unit 400 receives from the comparison value processing unit 140 the comparison value vector [S_{a,1}, S_{a,2}, S_{a,3}] of the a-th candidate, for which first through third biometric information is registered.

The biometric information comparison value binary classification unit 420 determines whether the comparison value vector [S_{a,1}, S_{a,2}, S_{a,3}] is a comparison value vector generated by comparing a plurality of pieces of biometric information of the same person or a comparison value vector generated by comparing a plurality of pieces of biometric information of different persons, and outputs the determination result as a discriminant value fₐ′. The operation of the biometric information comparison value binary classification unit 420 will become more apparent with reference to Korean Patent Application No. 10-2005-0024054 entitled, “Multiple Biometric Identification Method and System.”

The class-conditional probability calculation unit 440 calculates class-conditional probabilities P(fₐ′|G) (442) and P(fₐ′|I) (444) of the discriminant value fₐ′ provided by the biometric information comparison value binary classification unit 420.

The posterior probability calculation unit 460 calculates a posterior probability P(G|fₐ′), which is the probability that the discriminant value fₐ′ has been generated by comparing a plurality of pieces of biometric information of the same person, as indicated in Equation (10). Thereafter, the posterior probability calculation unit 460 provides the posterior probability P(G|fₐ′) as the unified comparison value fₐ for the a-th candidate, and more particularly, for the comparison value vector [S_{a,1}, S_{a,2}, S_{a,3}].

$${f}_{a} = P ( G \vert {f}_{a}^{′} ) = \frac{P ( {f}_{a}^{′} \vert G ) P ( G )}{P ( {f}_{a}^{′} \vert G ) P ( G ) + P ( {f}_{a}^{′} I ) P ( I )} Λ . \qquad ( 10 )$$

According to the current embodiment of the present application, the discriminant value fₐ′ is used to calculate the unified comparison value fₐ for the a-th candidate because the learning of a binary classifier is easier than and the binary classifier offers better performance than the estimation of a probability distribution of multi-dimensional data. As described above, by estimating a probability distribution of 1-dimensional data, i.e., a discriminant value output by a binary classifier, it is possible to easily configure a multiple biometric identification system.

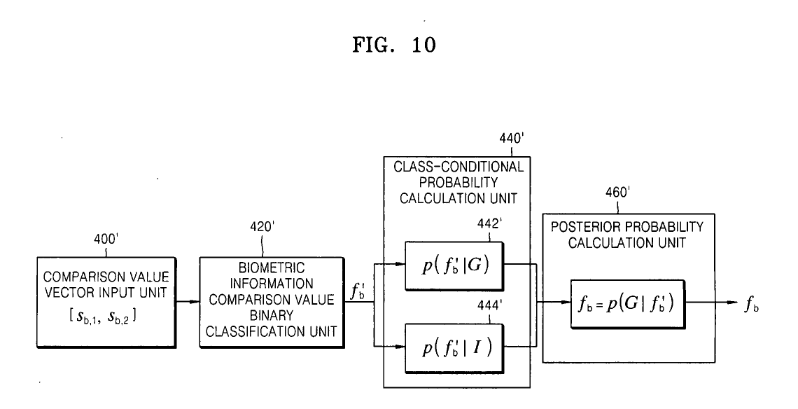

FIG. 10 is a schematic block diagram of the second unified comparison value generator 164 illustrated in FIG. 1. Referring to FIG. 10, the comparison value vector input unit 400′ receives from the comparison value processing unit 140 the comparison value vector [S_{b,1}, S_{b,2}] of the b-th candidate, for which first and second biometric information is registered.

The biometric information comparison value binary classification unit 420′ determines whether the comparison value vector [S_{b,1}, S_{b,2}] is a comparison value vector generated by comparing a plurality of pieces of biometric information of the same person or a comparison value vector generated by comparing a plurality of pieces of biometric information of different persons, and outputs the determination result as a discriminant value f_{b}′.

The class-conditional probability calculation unit 440′ calculates class-conditional probabilities P(f_{b}′|G) (442′) and P(f_{b}′|I) (444′) of the discriminant value f_{b}′ provided by the biometric information comparison value binary classification unit 420′.

The posterior probability calculation unit 460′ calculates a posterior probability P(G|f_{b}′), which is the probability that the discriminant value f_{b}′ has been generated by comparing a plurality of pieces of biometric information of the same person, as indicated in Equation (11). Thereafter, the posterior probability calculation unit 460′ provides the posterior probability P(G|f_{b}′) as the unified comparison value fₐ for the b-th candidate, and more particularly, for the comparison value vector [S_{b,1}, S_{b,2}].

$${f}_{b} = P ( G \vert {f}_{b}^{′} ) = \frac{P ( {f}_{b}^{′} \vert G ) P ( G )}{P ( {f}_{b}^{′} \vert G ) P ( G ) + P ( {f}_{b}^{′} I ) P ( I )} Λ . \qquad ( 11 )$$

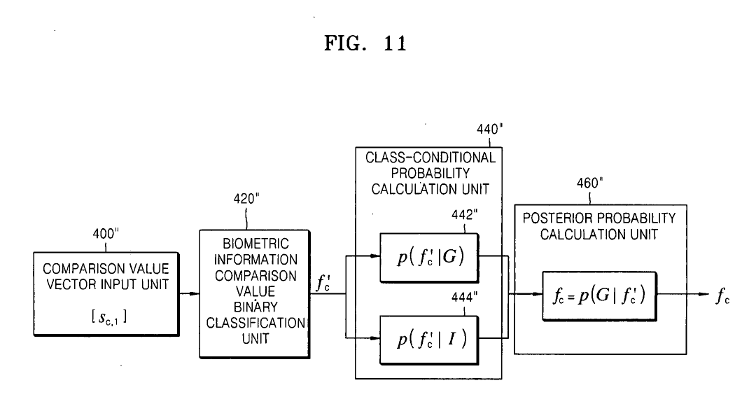

FIG. 11 is a schematic block diagram of the fifth unified comparison value generator 170 illustrated in FIG. 1. Referring to FIG. 11, the comparison vector input unit 400″ receives from the comparison value processing unit 140 the comparison value vector [S_{c,1}] of the c-th candidate, for which first biometric information is registered.

The biometric information comparison value binary classification unit 420″ determines whether the comparison value vector [S_{c,1}] is a comparison value vector generated by comparing a plurality of pieces of biometric information of the same person or a comparison value vector generated by comparing a plurality of pieces of biometric information of different persons, and outputs the determination result as a discriminant value f_{c}′.

The class-conditional probability calculation unit 440″ calculates class-conditional probabilities P(f_{c}′|G) (442″) and P(f_{c}′|I) (444″) of the discriminant valuer f_{c}′ provided by the biometric information comparison value binary classification unit 420″.

The posterior probability calculation unit 460′ calculates a posterior probability P(G|f_{c}′), which is the probability that the discriminant value f_{c}′ has been generated by comparing a plurality of pieces of biometric information of the same person, as indicated in Equation (12). Thereafter, the posterior probability calculation unit 460′ provides the posterior probability P(G|f_{c}′) as the unified comparison value f_{c} for the c-th candidate, and more particularly, for the comparison value vector [S_{c,1}].

$${f}_{c} = P ( G \vert {f}_{c}^{′} ) = \frac{P ( {f}_{c}^{′} \vert G ) P ( G )}{P ( {f}_{c}^{′} \vert G ) P ( G ) + P ( {f}_{c}^{′} I ) P ( I )} Λ . \qquad ( 12 )$$

The unified comparison value generators other than those described above with reference to FIGS. 9 through 11 perform similar operations to those described above with reference to FIGS. 9 through 11, and thus, their detailed descriptions will be omitted.

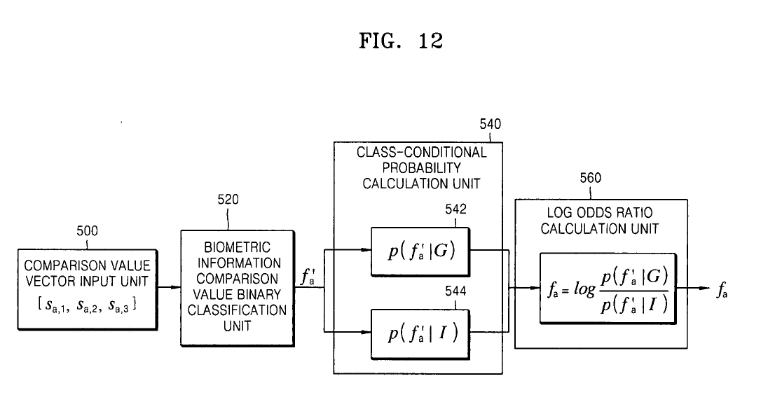

FIGS. 12 through 14 are block diagrams of the first, second, and fifth unified comparison value generators 162, 164, and 170, respectively, according to another embodiment of the present invention. Referring to FIGS. 12 through 14, the first, second, and fifth unified comparison value generators 162, 164, and 170 respectively include comparison value vector input units 500, 500′, and 500″, biometric information comparison value binary classification units 520, 520′, 520″, class-conditional probability calculation units 540, 540′, and 540″, and the log of odds ratio calculation units 560, 560′, and 560″. A method of generating a unified comparison value using a discriminant value of a binary classifier for a comparison vector and the log of the odds ratio of a class-conditional probability of the discriminant value will now be described in detail with reference to FIGS. 12 through 14.

Referring to FIGS. 12 through 14, the comparison value vector input units 500, 500′, and 500″, the biometric information comparison value binary classification units 520, 520′, and 520″, and the class-conditional probability calculation units 540, 540′, and 540″ respectively perform the same operations as the comparison value vector input units 400, 400′, 400″, the biometric information comparison value binary classification units 420, 420′, and 420″, and the class-conditional probability calculation units 440, 440′, and 440″ described above with reference to FIGS. 9 through 11, and thus, their detailed descriptions will be omitted. The operation of the log of odds ratio calculation units 560, 560′, and 560″ will now be described in detail.

FIG. 12 is a schematic block diagram of the first unified comparison value generator 162 illustrated in FIG. 1. Referring to FIG. 12, the log of odds ratio calculation unit 560 calculates the log of the odds ratio of a posterior probability P(G|fₐ′) using class-conditional probabilities P(fₐ′|G) (542) and P(fₐ′|I) (544) calculated by the class-conditional probability calculation unit 540 and provides the log of the odds ratio of a posterior probability P(G|fₐ′) as the unified comparison value fₐ for the a-th candidate, and more particularly, for the comparison value vector [S_{a,1}, S_{a,2}, S_{a,3}]. The calculation of the unified comparison value fₐ for the a-th candidate is similar to the calculation of the unified comparison value fₐ for the a-th candidate described above with reference to FIG. 6, and satisfies Equation (13):

$$P ( G \vert {f}_{a}^{′} ) ∝ log \frac{P ( G \vert {f}_{a}^{′} )}{P ( I \vert {f}_{a}^{′} )} ∝ log \frac{P ( {f}_{a}^{′} \vert G )}{P ( {f}_{a}^{′} \vert I )} Λ . \qquad ( 13 )$$

Therefore, the unified comparison value fₐ for the a-th candidate is calculated as indicated in Equation (14):

$${f}_{a} = log \frac{P ( {f}_{a}^{′} \vert G )}{P ( {f}_{a}^{′} \vert I )} . \qquad ( 14 )$$

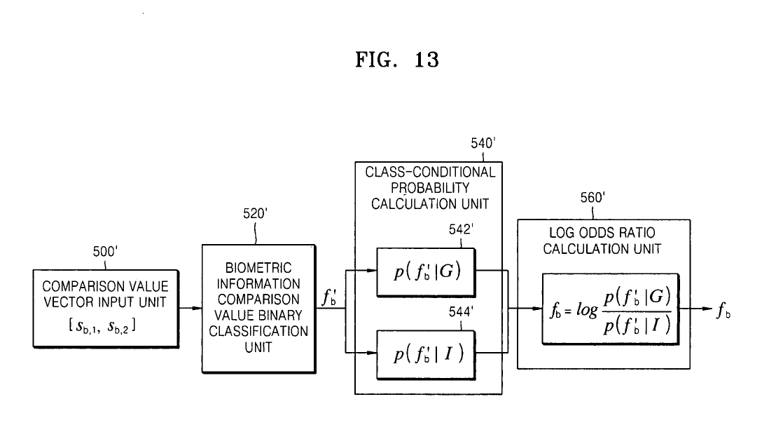

FIG. 13 is a schematic block diagram of the second unified comparison value generator 164 illustrated in FIG. 1. Referring to FIG. 13, the log of odds ratio calculation unit 560′ calculates the log of the odds ratio of a posterior probability P(G|f_{b}′) using class-conditional probabilities P(f_{b}′|G) (542′) and P(f_{b}′|I) (544′) calculated by the class-conditional probability calculation unit 540′ and provides the log of the odds ratio of a posterior probability P(G|f_{b}′) as the unified comparison value f_{b} for the b-th candidate, and more particularly, for the comparison value vector [S_{b,1}, S_{b,2}]. The calculation of the unified comparison value f_{b} for the b-th candidate is similar to the calculation of the unified comparison value f_{b} for the b-th candidate described above with reference to FIG. 7. As a result, the unified comparison value f_{b} for the b-th candidate is calculated as indicated in Equation (15):

$${f}_{b} = log \frac{P ( {f}_{b}^{′} \vert G )}{P ( {f}_{b}^{′} \vert I )} . \qquad ( 15 )$$

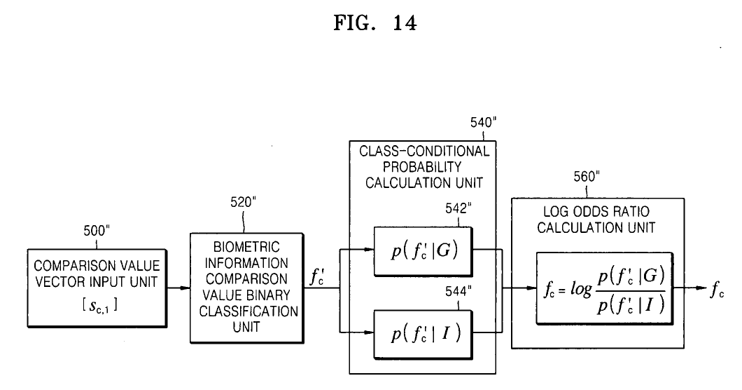

FIG. 14 is a schematic block diagram of another example of the fifth unified comparison value generator 170 illustrated in FIG. 1. Referring to FIG. 14, the log of odds ratio calculation unit 560″ calculates the log of the odds ratio of a posterior probability P(G|f_{c}′) using class-conditional probabilities P(f_{c}′|G) (542″) and P(f_{c}′|I) (544″) calculated by the class-conditional probability calculation unit 540″ and provides the log of the odds ratio of a posterior probability P(G|f_{c}40 ) as the unified comparison value f_{c} for the c-th candidate, and more particularly, for the comparison value vector [S_{c,1}]. The calculation of the unified comparison value f_{c} for the c-th candidate is similar to the calculation of the unified comparison value f_{c} for the c-th candidate described above with reference to FIG. 8. As a result, the unified comparison value f_{c} for the c-th candidate is calculated as indicated in Equation (16):

$${f}_{c} = log \frac{P ( {f}_{c}^{′} \vert G )}{P ( {f}_{c}^{′} \vert I )} . \qquad ( 16 )$$

The unified comparison value generators other than those described above with reference to FIGS. 12 through 14 perform similar operations to those described above with reference to FIGS. 12 through 14, and thus, their detailed descriptions will be omitted.

As described above, the comparison value generation unit 160 generates unified comparison values so that comparison value vectors of candidates who may have different combinations of biometric information can be compared with one another. Therefore, it is possible to perform multiple biometric identification even when the type and quantity of biometric information differs from one candidate to another.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multiple biometric identification system which identifies multiple biometric information of a user who requests to be identified, the multiple biometric identification system comprising:
a biometric identification unit which compares multiple biometric information of the user with multiple biometric information of each of a plurality of candidates registered in advance, thereby generating a plurality of single biometric information comparison values for respective corresponding pieces of single biometric information constituting the multiple biometric information of each of the candidates;
a comparison value processing unit which generates a plurality of comparison value vectors for the respective candidates based on the single biometric information comparison values and classifies the comparison value vectors according to the combination of single biometric information of each of the comparison value vectors;
a comparison value generation unit which converts the comparison value vectors generated by the comparison value processing unit into a plurality of unified comparison values for the respective candidates so that the candidates which have different combinations of single biometric information can be effectively compared with the user; and
an identification list generation unit which generates a candidate list in which the candidates who are likely to be determined to be a match for the user through multiple biometric identification based on the single comparison values are listed in a predetermined manner.

2. The multiple biometric identification system of claim 1, wherein the single biometric information comparison values are numeric values indicating how much single biometric information of the user matches single biometric information of the candidates.

3. The multiple biometric identification system of claim 1, wherein the biometric identification unit comprises a plurality of single biometric information identification units which respectively recognize single biometric information constituting the multiple biometric information of the user and the single biometric information of the multiple biometric information of each of the candidates,
wherein each of the single biometric information identification units generates a plurality of single biometric information comparison values for the respective candidates, indicating a single biometric information comparison value corresponding to unregistered single biometric information of a candidate as a null value.

4. The multiple biometric identification system of claim 3, wherein each of the comparison value vectors comprises a combination of all the single biometric identification information comparison values of the corresponding candidate except for the null values.

5. The multiple biometric identification system of claim 1 further comprising a normalization unit which normalizes the single biometric information comparison values,
wherein the comparison value processing unit generates the comparison value vectors for the respective candidates by comparing the normalized single biometric information comparison values.

6. The multiple biometric identification system of claim 1, wherein the comparison value generation unit comprises a plurality of single comparison value generators, the number of which corresponds to the number of possible combinations of single biometric information which is recognized by the biometric identification unit,
wherein the single comparison value generators generate the unified comparison values based on the comparison value vectors generated by the comparison value processing unit, thereby enabling a comparison vector generated using one biometric information combination to be compared with a comparison vector generated using single biometric information combination.

7. The multiple biometric identification system of claim 6, wherein each of the single comparison value generators comprises:
a comparison value vector input unit which receives from the comparison value processing unit a comparison value vector of an a-th candidate for which at least one type of biometric information is registered;
a class-conditional probability calculation unit which calculates a class-conditional probability P(Comparison Value Vector of a-th Candidate|G), which is the likelihood that a comparison value vector is observed from a class G
, and a class-conditional probability P(Comparison Value Vector of a-th Candidate|I), which is the likelihood that a comparison value vector is observed from a class I, wherein G indicates a class of comparison value vectors generated by comparing biometric information of the same person, and I indicates a class of comparison value vectors generated by comparing biometric information of different persons; and
a posterior probability calculation unit which calculates, as a unified comparison value fₐ for the a-th candidate, a posterior probability P(G|Comparison Value Vector of a-th Candidate), which is the probability that the comparison value vector of the a-th candidate has been generated by comparing biometric information of the same person, using the class-conditional probabilities P(Comparison Value Vector of a-th Candidate|G) and P(Comparison Value Vector of a-th Candidate|I) and prior probabilities P(G) and P(I), which are values predefined by a system designer, as indicated in the following equation:
$$\begin{matrix}{f}_{a} = P ( G \vert Comparison Vector of a \text{-} th Candidate ) \\ = \frac{P ( Comparison Vector of a \text{-} th Candidate \vert G ) P ( G )}{\begin{matrix}P ( Comparison Vector of a \text{-} th Candidate \vert G ) P ( G ) + \\ P ( Comparison Vector of a \text{-} th Candidate \vert I ) P ( I )\end{matrix}} . \\ \end{matrix}$$

8. The multiple biometric identification system of claim 6, wherein each of the single comparison value generators comprises:
a comparison value vector input unit which receives from the comparison value processing unit a comparison value vector of an a-th candidate, for which at least one type of biometric information is registered;
a class-conditional probability calculation unit which calculates a class-conditional probability P(Comparison Value Vector of a-th Candidate|G), ), which is the likelihood that a comparison value vector is observed from a class G, and a class-conditional probability P(Comparison Value Vector of a-th Candidate|I), which is the likelihood that a comparison value vector is observed from a class I, wherein G indicates a class of comparison value vectors generated by comparing biometric information of the same person, and I indicates a class of comparison value vectors generated by comparing biometric information of different persons; and
a log of odds ratio calculation unit which calculates, as a unified comparison value fₐ for the a-th candidate, the log of the odds ratio of a posterior probability P(G|Comparison Value Vector of a-th Candidate), which is the probability that the comparison value vector of the a-th candidate has been generated by comparing biometric information of the same person, using the class-conditional probabilities P(Comparison Value Vector of a-th Candidate|G) and P(Comparison Value Vector of a-th Candidate|I) as indicated in the following equation:
$${f}_{a} = log \frac{P ( Comparison Value Vector of a \text{-} th Candidate \vert G )}{P ( Comparison Value Vector of a \text{-} th Candidate \vert I )} .$$

9. The multiple biometric identification system of claim 6, wherein each of the single comparison value generators comprises:
a comparison value vector input unit which receives from the comparison value processing unit a comparison value vector of an a-th candidate for which at least one type of biometric information is registered;
a biometric information comparison value binary classification unit which determines whether the comparison value vector of the a-th candidate is a comparison value vector generated by comparing biometric information of the same person or a comparison value vector generated by comparing biometric information of different persons, and outputs the determination result as a discriminant value fₐ′;
a class-conditional probability calculation unit which calculates class-conditional probabilities P(fₐ′|G) and P(fₐ′|I) of the discriminant value fₐ′ provided by the biometric information comparison value binary classification unit, wherein G indicates a class of comparison value vectors generated by comparing biometric information of the same person, and I indicates a class of comparison value vectors generated by comparing biometric information of different persons; and
a posterior probability calculation unit which calculates, as a unified comparison value fₐ for the a-th candidate, a posterior probability P(G|fₐ′), which is the probability that the discriminant value fₐ′ has been generated by comparing biometric information of the same person, using the class-conditional probabilities P(fₐ′|G) and P(fₐ′|I) and prior probabilities P(G) and P(I), which are values predefined by a system designer, as indicated in the following equation:
$${f}_{a} = P ( G \vert {f}_{a}^{′} ) = \frac{P ( {f}_{a}^{′} \vert G ) P ( G )}{P ( {f}_{a}^{′} \vert G ) P ( G ) + P ( {f}_{a}^{′} I ) P ( I )} .$$

10. The multiple biometric identification system of claim 6, wherein each of the single comparison value generators comprises:
a comparison value vector input unit which receives from the comparison value processing unit a comparison value vector of an a-th candidate for which at least one type of biometric information is registered;
a biometric information comparison value binary classification unit which determines whether the comparison value vector of the a-th candidate is a comparison value vector generated by comparing biometric information of the same person or a comparison value vector generated by comparing biometric information of different persons, and outputs the determination result as a discriminant value fₐ′;
a class-conditional probability calculation unit which calculates class-conditional probabilities P(fₐ′|G) and P(fₐ′|I) of the discriminant value fₐ′ provided by the biometric information comparison value binary classification unit, wherein G indicates a class of comparison value vectors generated by comparing biometric information of the same person, and I indicates a class of comparison value vectors generated by comparing biometric information of different persons; and
a log of odds ratio calculation unit which calculates, as a unified comparison value fₐ for the a-th candidate, the log of the odds ratio of a posterior probability P(G|fₐ′), which is the probability that the discriminant value fₐ′ has been generated by comparing biometric information of the same person, using the class-conditional probabilities P(fₐ′|G) and P(fₐ′|I) as indicated in the following equation:
$${f}_{a} = log \frac{P ( {f}_{a}^{′} \vert G )}{P ( {f}_{a}^{′} \vert I )} .$$

11. A multiple biometric identification system method of identifying multiple biometric information of a user who requests to be identified using a plurality of single biometric identification systems, the multiple biometric identification method comprising:
(a) comparing multiple biometric information of the user with multiple biometric information of each of a plurality of candidates registered in advance using each of the single biometric identification systems, thereby generating a plurality of single biometric information comparison values for respective corresponding pieces of the multiple biometric information of each of the candidates;
(b) generating a plurality of comparison value vectors for the respective candidates based on the single biometric information comparison values;
(c) classifying the comparison value vectors according to the combination of single biometric information of each of the comparison value vectors;
(d) converting the classified comparison value vectors into a plurality of unified comparison values for the respective candidates so that the candidates which have different combinations of single biometric information can be effectively compared with the user; and
(e) generating a candidate list in which the candidates who are likely to be determined to be a match for the user through multiple biometric identification based on the single comparison values are listed in a predetermined manner.

12. The multiple biometric identification method of claim 11, wherein the single biometric information comparison values are numeric values indicating how much single biometric information of the user matches single biometric information of the candidates.

13. The multiple biometric identification method of claim 11, wherein the single biometric information comparison values that correspond to unregistered single biometric information of a candidate are indicated as null values.

14. The multiple biometric identification method of claim 11, wherein each of the comparison value vectors comprises a combination of all the single biometric identification information comparison values of the corresponding candidate except for the null values.

15. The multiple biometric identification method of claim 11, wherein operation (b) comprises:
(b-1) normalizing the single biometric information comparison values; and
(b-2) generating the comparison value vectors for the respective candidates by comparing the normalized single biometric information comparison values.

16. The multiple biometric identification method of claim 11, wherein operation (d) comprises:
(d1_{—}1) receiving a comparison value vector of an a-th candidate for which at least one type of biometric information is registered;
(d1_{—}2) calculating a class-conditional probability P(Comparison Value Vector of a-th Candidate|G), which is the likelihood that a comparison value vector is observed from a class G, and a class-conditional probability P(Comparison Value Vector of a-th Candidate|I), which is the likelihood that a comparison value vector is observed from a class I, wherein G indicates a class of comparison value vectors generated by comparing biometric information of the same person, and I indicates a class of comparison value vectors generated by comparing biometric information of different persons; and
(d1_{—}3) calculating, as a unified comparison value fₐ for the a-th candidate, a posterior probability P(G|Comparison Value Vector of a-th Candidate), which is the probability that the comparison value vector of the a-th candidate has been generated by comparing biometric information of the same person, using the class-conditional probabilities P(Comparison Value Vector of a-th Candidate|G) and P(Comparison Value Vector of a-th Candidate|I) and prior probabilities P(G) and P(I), which are values predefined by a system designer, as indicated in the following equation:
$$\begin{matrix}{f}_{a} = P ( G \vert Comparison Vector of a \text{-} th Candidate ) \\ = \frac{P ( Comparison Vector of a \text{-} th Candidate \vert G ) P ( G )}{\begin{matrix}P ( Comparison Vector of a \text{-} th Candidate \vert G ) P ( G ) + \\ P ( Comparison Vector of a \text{-} th Candidate \vert I ) P ( I )\end{matrix}} .\end{matrix}$$

17. The multiple biometric identification method of claim 11, wherein operation (d) comprises:
(d2_{—}1) receiving a comparison value vector of an a-th candidate for which at least one type of biometric information is registered;
(d2_{—}2) calculating a class-conditional probability P(Comparison Value Vector of a-th Candidate|G), which is the likelihood that a comparison value vector is observed from a class G, and a class-conditional probability P(Comparison Value Vector of a-th Candidate|I), which is the likelihood that a comparison value vector is observed from a class I, wherein G indicates a class of comparison value vectors generated by comparing biometric information of the same person, and I indicates a class of comparison value vectors generated by comparing biometric information of different persons; and
(d2_{—}3) calculating, as a unified comparison value fₐ for the a-th candidate, the log of the odds ratio of a posterior probability P(G|Comparison Value Vector of a-th Candidate), which is the probability that the comparison value vector of the a-th candidate has been generated by comparing biometric information of the same person, using the class-conditional probabilities P(Comparison Value Vector of a-th Candidate|G) and P(Comparison Value Vector of a-th Candidate|I) as indicated in the following equation:
$${f}_{a} = log \frac{P ( Comparison Value Vector of a \text{-} th Candidate \vert G )}{P ( Comparison Value Vector of a \text{-} th Candidate \vert I )} .$$

18. The multiple biometric identification method of claim 17, wherein operation (d2_{—}3) comprises:
(d2_{—}31) calculating the log of the odds ratio of the posterior probability P(G|Comparison Value Vector of a-th Candidate), which is defined by the following equation:
$$log \frac{P ( G \vert Comparison Value Vector of a \text{-} th Candidate )}{P ( I \vert Comparison Value Vector of a \text{-} th Candidate )} ,$$
by calculating the sum of the log of the odds ratio between the class-conditional probabilities P(Comparison Value Vector of a-th Candidate|G) and P(Comparison Value Vector of a-th Candidate|I) and the log of the odds ratio of prior probabilities P(G) and P(I) as indicated in the following equation:
$$log \frac{P ( G \vert Comparison Value Vector of a \text{-} th Candidate )}{P ( I \vert Comparison Value Vector of a \text{-} th Candidate ) ,}$$
$$\begin{matrix} = log \frac{\frac{P ( Comparison Value Vector of a \text{-} th Candidate \vert G ) P ( G )}{\begin{matrix}P ( Comparison Value Vector of a \text{-} th Candidate \vert G ) P ( G ) + \\ P ( Comparison Value Vector of a \text{-} th Candidate \vert I ) P ( I ) )\end{matrix}}}{\begin{matrix}\frac{P ( Comparison Value Vector of a \text{-} th Candidate \vert I ) P ( I )}{P ( Comparison Value Vector of a \text{-} th Candidate \vert G ) P ( G ) +} \\ P ( Comparison Value Vector of a \text{-} th Candidate \vert I ) P ( I )\end{matrix}} \\ = log \frac{P ( Comparison Value Vector of a \text{-} th Candidate \vert G ) P ( G )}{P ( Comparison Value Vector of a \text{-} th Candidate \vert I ) P ( I )} \\ = log = \frac{P ( Comparison Value Vector of a \text{-} th Candidate \vert G )}{P ( Comparison Value Vector of a \text{-} th Candidate \vert I )} + log \frac{P ( G )}{P ( I )} ,\end{matrix}$$
wherein the prior probabilities P(G) and P(I) are values predefined by a system designer through learning;
(d2_{—}32) calculating a proportional relationship between the posterior probability P(G|Comparison Value Vector of a-th Candidate) and the log of the odds ratio of the posterior probability P(G|Comparison Value Vector of a-th Candidate) as indicated in the following equation:
$$P ( G \vert Comparison Value Vector of a \text{-} th Candidate ) ∝ log \frac{P ( G \vert Comparison Value Vector of a \text{-} th Candidate )}{P ( I \vert Comparison Value Vector of a \text{-} th Candidate )} ; ∝ log \frac{P ( Comparison Value Vector of a \text{-} th Candidate \vert G )}{P ( Comparison Value Vector of a \text{-} th Candidate \vert I )}$$
and
(d2_{—}33) calculating the unified comparison value fₐ for the a-th candidate using the proportional relationship between the posterior probability P(G|Comparison Value Vector of a-th Candidate) and the log of the odds ratio of the posterior probability P(G|Comparison Value Vector of a-th Candidate).

19. The multiple biometric identification method of claim 11, wherein operation (d) comprises:
(d3_{—}1) receiving a comparison value vector of an a-th candidate for which at least one type of biometric information is registered;
(d3_{—}2) determining whether the comparison value vector of the a-th candidate is a comparison value vector generated by comparing biometric information of the same person or a comparison value vector generated by comparing biometric information of different persons, and obtaining a discriminant value fₐ′ as the determination result;
(d3_{—}3) calculating class-conditional probabilities P(fₐ′|G) and P(fₐ′|I) of the discriminant value fₐ′, wherein G indicates a class of comparison value vectors generated by comparing biometric information of the same person, and I indicates a class of comparison value vectors generated by comparing biometric information of different persons; and
(d3_{—}4) calculating, as a unified comparison value fₐ for the a-th candidate, a posterior probability P(G|fₐ′), which is the probability that the discriminant value fₐ′ has been generated by comparing biometric information of the same person, using the class-conditional probabilities P(fₐ′|G) and P(fₐ′|I) and prior probabilities P(G) and P(I), which are values predefined by a system designer, as indicated in the following equation:
$${f}_{a} = P ( G \vert {f}_{a}^{′} ) = \frac{P ( {f}_{a}^{′} \vert G ) P ( G )}{P ( {f}_{a}^{′} \vert G ) P ( G ) + P ( {f}_{a}^{′} \vert I ) P ( I )} .$$

20. The multiple biometric identification method of claim 19, wherein operation (d3_{—}2) comprises:
(d3_{—}21) determining whether the comparison value vector of the a-th candidate is a comparison value vector generated by comparing biometric information of the same person or a comparison value vector generated by comparing biometric information of different persons using a binary classifier; and
(d3_{—}22) generating, as the determination result, the discriminant value fₐ′, which indicates whether the comparison value vector of the a-th candidate is a comparison value vector generated by comparing biometric information of the same person or a comparison value vector generated by comparing biometric information of different persons.

21. The multiple biometric identification method of claim 11, wherein operation (d) comprises:
(d4_{—}1) receiving a comparison value vector of an a-th candidate for which at least one type of biometric information is registered;
(d4_{—}2) determining whether the comparison value vector of the a-th candidate is a comparison value vector generated by comparing biometric information of the same person or a comparison value vector generated by comparing biometric information of different persons, and obtaining a discriminant value fₐ′ as the determination result;
(d4_{—}3) calculating class-conditional probabilities P(fₐ′|G) and P(fₐ′|I) of the discriminant value fₐ′, wherein G indicates a class of comparison value vectors generated by comparing biometric information of the same person, and I indicates a class of comparison value vectors generated by comparing biometric information of different persons; and
(d4_{—}4) calculating, as a unified comparison value fₐ for the a-th candidate, the log of the odds ratio of a posterior probability P(G|fₐ′), which is the probability that the discriminant value fₐ′ has been generated by comparing biometric information of the same person, using the class-conditional probabilities P(fₐ′|G) and P(fₐ′|I) as indicated in the following equation:
$${f}_{a} = log \frac{P ( {f}_{a}^{′} \vert G )}{P ( {f}_{a}^{′} \vert I )} .$$

22. The multiple biometric identification method of claim 21, wherein operation (d4_{—}2) comprises:
(d4_{—}21) determining whether the comparison value vector of the a-th candidate is a comparison value vector generated by comparing biometric information of the same person or a comparison value vector generated by comparing biometric information of different persons using a binary classifier; and
(d4_{—}22) generating, as the determination result, the discriminant value fₐ′, which indicates whether the comparison value vector of the a-th candidate is a comparison value vector generated by comparing biometric information of the same person or a comparison value vector generated by comparing biometric information of different persons.

23. The multiple biometric identification method of claim 21, wherein operation (d4_{—}3) comprises:
(d4_{—}31) calculating the log of the odds ratio of the posterior probability P(G|fₐ′), which is defined by the following equation:
$$log \frac{P ( G \vert {f}_{a}^{′} )}{P ( I \vert {f}_{a}^{′} )} ,$$
by calculating the sum of the log of the odds ratio between the class-conditional probabilities P(fₐ′|G) and P(fₐ′|I) and the log of the odds ratio of prior probabilities P(G) and P(I) as indicated in the following equation:
$$log \frac{P ( G \vert {f}_{a}^{′} )}{P ( I \vert {f}_{a}^{′} )} , = log \frac{\frac{P ( {f}_{a}^{′} \vert G ) P ( G )}{P ( {f}_{a}^{′} \vert G ) P ( G ) + P ( {f}_{a}^{′} \vert I ) P ( I ) )}}{\frac{P ( {f}_{a}^{′} \vert I ) P ( I )}{P ( {f}_{a}^{′} \vert G ) P ( G ) + P ( {f}_{a}^{′} \vert I ) P ( I )}} = log \frac{P ( {f}_{a}^{′} \vert G ) P ( G )}{P ( {f}_{a}^{′} \vert I ) P ( I )} = log = \frac{P ( {f}_{a}^{′} \vert G )}{P ( {f}_{a}^{′} \vert I )} + log \frac{P ( G )}{P ( I )} ,$$
wherein the prior probabilities P(G) and P(I) are values predefined by a system designer through learning;
(d4_{—}32) calculating the proportional relationship between the posterior probability P(G|fₐ′) and the log of the odds ratio of the posterior probability P(G|fₐ′) as indicated in the following equation:
$$P ( G \text{\vert} {f}_{a}^{′} ) ∝ log \frac{P ( G \text{\vert} {f}_{a}^{′} )}{P ( I \text{\vert} {f}_{a}^{′} )} ∝ log \frac{P ( {f}_{a}^{′} \text{\vert} G )}{P ( {f}_{a}^{′} \text{\vert} I )} ; and$$
(d4_{—}33) calculating the unified comparison value fₐ for the a-th candidate using the proportional relationship between the posterior probability P(G|fₐ′) and the log of the odds ratio of the posterior probability P(G|fₐ′).
